(19) United States
(12) Patent Application Publication
(10) Pub. No.: US 2010/0107188 A1
(43) Pub. Date: Apr. 29, 2010

(54) INTERSTITIAL ADVERTISEMENTS ASSOCIATED WITH CONTENT DOWNLOADS

(75) Inventor: Arthur Anthonie van Hoff, Menlo Park, CA (US)

Correspondence Address: Workman Nydegger;1000 Eagle Gate Tower, 60 East South Temple, Salt Lake City, UT, 84111, US

(73) Assignee: Dell Products L.P., Round Rock, TX (US)

(21) Appl. No.: 12/257,963

(22) Filed: Oct. 24, 2008

(51) Int. Cl. H04N 7/10

(52) U.S. Cl. 725/32

(57) ABSTRACT

A method and system for a media device to interstitially place advertisement data between content data. The method may include receiving content data and advertisement data. Desired content may then be selected. Advertisement data that is related to the selected content is also selected. A data stream that includes the advertisement data interstitially placed between the content data is then generated and communicated to the user of the device. In this way, free downloads of content may be provided.

### CROSS-REFERENCE TO RELATED APPLICATIONS

Not applicable.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One of the advantages afforded by technological improvements is the ability to distribute to digital media. However, the ability of information handling systems to distribute digital media has not kept pace with the ways in which digital media can be distributed, the wide variety of digital media, or with the growing diversity among media devices.

For example, digital media (e.g., music, video, Internet data, sports data, news data, weather data, etc.) can be distributed to media devices via various networks including the Internet as well as wireless communication, such as satellite radio, WiFi, cellular networks, and the like. Given the diversity of media devices and media content, many different types of devices have been developed to enjoy the growing availability of digital media, including MP3 players, portable CD players, portable DVD players, notebook computers, cellular telephones, personal digital assistants (PDAs), are examples of such devices. Digital media can also be enjoyed on other non-portable devices as well such as on desk top computers.

Because high quality digital media can be delivered over various types of networks in relatively short time frames, it is becoming increasingly difficult to control the distribution of the media as well as ensure that media content providers, including distribution entities, artists, and others, are properly compensated.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An embodiment disclosed herein relates to a method for interstitially placing advertisement data between content data. The method may be practiced in a system including a media device that is configured to store content data and is configured to store advertisement data. The method comprises selecting content data stored in a memory of a media device, selecting advertisement data stored in the memory of the media device, and at the media device, generating an output data stream comprising the selected content data and the selected advertisement data, wherein the advertisement data is interstitially placed between portions of the content data.

Another embodiment disclosed herein relates to a method for interstitially placing advertisement data between content data. The method may be practiced in a system including a media device that is configured to receive content data from one or more content providers and is configured to receive advertisement data from one or more advertisement providers. The method comprises receiving content data from one or more content providers, receiving advertisement data from one or more advertisement providers, selecting at least a portion of the received content data, selecting at least a portion of the received advertisement data, and generating an output data stream comprising the selected content data and the selected advertisement data, wherein the advertisement data is interstitially placed between portions of the content data.

A further embodiment disclosed herein relates to a media device configured to generate a data stream that includes advertisement data interstitially placed between content data. The media device comprises a memory, a processing unit, a selection module configured to select or identify content data received by the media device, an advertisement module configured to select one or more advertisement data received by the media device, and an output module configured to access the selected or identified content data and the selected advertisement data and to generate an output data stream comprising the selected or identified content data and the selected advertisement data, wherein the advertisement data is interstitially placed between portions of the content data.

Additional features and advantages will be set forth in the description which follows, and in part will be obvious from the description, or may be learned by the practice of the teaching herein. The features and advantages of the teaching herein may be realized and obtained by means of the instruments and combinations particularly pointed out in the appended claims. These and other features will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a schematic drawing of one embodiment of a media device;

FIG. 2 illustrates a system including one embodiment of a media device configured to interface with content and advertisement providers;

FIGS. 3A-3D illustrate one embodiment of a process flow for a media device to interstitially place one or more advertisements between one or more types of content;

FIG. 4 illustrates one embodiment of a flow chart of a method for a media device to interstitially placing advertisement data between content data; and

FIG. 5 a flow chart of a certain method for a media device to interstitially placing advertisement data between content data.

### DETAILED DESCRIPTION

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, leisure, educational, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Embodiments of the invention relate to systems and methods for delivering content to a media device. Delivering content includes an information handling system that may operate on a user's device to insure that certain content is performed along with other content. In one example, the information handling system may ensure that content such as advertising content is performed with other content such as video or music. For example, the information handling system may operate to generate a data stream that includes both advertising content and other content. The data stream can be generated in real-time, offline, from multiple content sources, and the like as described more fully below. Advantageously, the ability to generate interstitial content enables users to have access to certain content while ensuring that the content provider is compensated for the content.

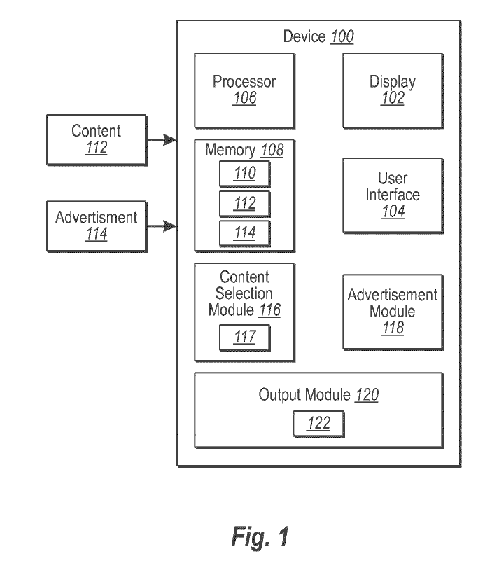

FIG. 1 illustrates an embodiment of a media device 100 that can receive content including digital media from one or more sources. Examples of the media device 100 may include, by way of example, a satellite radio device, a portable audio player such as a MP3 player or the like, a portable DVD or CD player, a personal computer, a laptop computer, a server computer, a cellular telephone, a personal digital assistant (PDA), and the like or any combination thereof. Embodiments of the invention may be implemented on portable media devices, but one of skill in the art can appreciate that embodiments of the invention can be used with other devices able to receive and render media content. Further, the media device 100 can be connected to various networks or other devices using wired and/or wireless communication.

Typically, the media device 100 includes a display 102 that can convey information to the user of the device. For example, when the media device 100 renders digital audio data, the display 102 may indicate the song title, the artist, the album title, the track number, the length of the track, and the like or any combination thereof

The media device 100 may also include a user interface 104 (such as control buttons, touch screen, capacitive input, etc.) or other means of providing input to the media device 100. The user interface 104, by way of example, enables a user to navigate, select and/or perform the digital media and other content that is stored on the memory 108 of the media device 100 or to navigate and perform any digital media or content that is received from an external source. The user interface 104 may enable a user to switch to another channel, such as in satellite radio, connect with a local network, such as a WiFi network, or otherwise operate to gain access to certain media content and store, buffer, and/or perform that media content.

The media device 100 may further include a processor 106. The processor 106 by way of example, enables media device 100 to execute various programs as circumstances warrant. In addition, the processor 106 may be utilized by one or more of the other modules or elements of media device 100 for processing operations.

The memory 108 of the device, which may include volatile and non-volatile memory or any combination thereof, can be used to store content or other user and/or device data. The memory 108, for example, may store digital music and/or video, graphics, play lists, user preferences, device settings, and the like or any combination thereof. As will be described in more detail to follow, the memory 108 may also store various advertisement data and the like.

The memory 108 may also store one or more user attributes 110. The user attributes 110 may include information about the user of media device 100. For example, the user attributes 110 may include demographic information such as gender, age, address, and occupation of the user. The user attributes 110 may also include various interests of the user such as favorite hobbies, books, music, sports, and the like. This information may be used to target advertisements for the user as will be explained in more detail to follow. In some embodiments, the user information 110 may be entered into memory 108 at the time the user purchases media device 100. In other embodiments, the user information 100 may be occasionally updated for various reasons, which may include ensuring that the user information is current. In certain embodiments, the user attributes 110 can be derived from use of the media device 100. For instance, the media device 100 may identify characteristics or other attributes that relate to the content that the device performs or accesses for the user. Usage statistics can therefore be included in the user attributes 110. In other examples, certain user attributes may be derived or inferred. For example, for users that decline to enter or provide certain data, the media device 100 may infer which types of music the user prefers based on usage patterns, channel selections, music purchases, and the like or any combination thereof.

The content 112 represents different types of media including digital media that may be received by the media device 100. Examples of the content 112 include, but are not limited to, digital music, talk or audio data, video data, television data, movie data, podcasts, sports data, weather data, news data, Internet data, and the like or any combination thereof. The content 112 can be either digital or analog in nature and may be converted by the device from one form to another or from one format to another format by the media device 100. As mentioned previously, content 112 may be stored in memory 108 upon being received by media device 100.

FIG. 1 illustrates that the media device 100 may also receive additional content 114, which is depicted as advertisements 114 in this example. The advertisements 114 represent different types of advertisements that may be received by media device 100. The advertisements 114 may include, but are not limited to, audio and visual advertisements including text, video, graphics, etc. The types of advertisements 114 that are received may be at least partially determined by the user attributes 110. The advertisements 114 may be stored in memory 108 upon being received by media device 100. The advertisements 114 may be associated with the content 112 as will be discussed in more detail to follow. Advantageously, use of advertisements 114 allows for the free downloading of content 112 and provides a way for content providers to control the distribution of content.

In certain embodiments, the advertisements 114 are interstitially associated with the content 112. In this example, the media device 100 may also include one or more additional modules configured to allow the advertisements 114 to be interstitially associated with the content 112. It will be appreciated that such modules may be comprised of software, hardware, or any combination of hardware and software. Further, these modules may be separate modules or they may be part of one or more modules.

For example, media device 100 may include a content selection module 116. Content selection module 116, which may be part of user interface 104, may be configured to monitor and identify the types of content 112 that the user of media device 100 selects, receives, and/or performs. For instance, the content selection module 116 may identify that a user has selected music content for a particular performer. Alternatively, the content selection module 116 may identify that a user has selected talk content related to a particular subject or from a particular channel or website, etc.

Content selection module 116 may also include or have access to one or more rules 117. Rules 117, which may include the common DMCA rules, govern how often content 112 may be played for free without the need for a separate license or the like. In other words, the content selection module 116 only allows media device 100 to play content 112 in a manner that is consistent with the rules 117. In this way, content selection module 116 is able to ensure that the content played by media device 100 may be played for free or may identify how the content may be performed relative to the related advertisement 114.

The media device 100 may also include an advertisement module 118. Advertisement module 118 may be configured to select various advertisements 114 stored in memory 108 to be interstitially associated with content 112. Advertisement module 118 may select the advertisements based on one or more of the user attributes 110, the type of content identified by selection module 116, or any combination thereof.

Media device 100 may further include an output module 120. Output module 120 may be configured to access the content 112 that has been selected by the user and the advertisements that have been selected by advertisement module 118. Output module 120 may then produce a data stream 122 that includes the content 112 with the advertisements 114 interstitially placed between the content 112. For example, the data stream 122 may include an advertisement placed before and after a song. The output module 120 may then provide this data stream to be played by media device 100. In certain embodiments, the data stream 122 including interstitially placed content may be generated at a server and delivered to the media device 100.

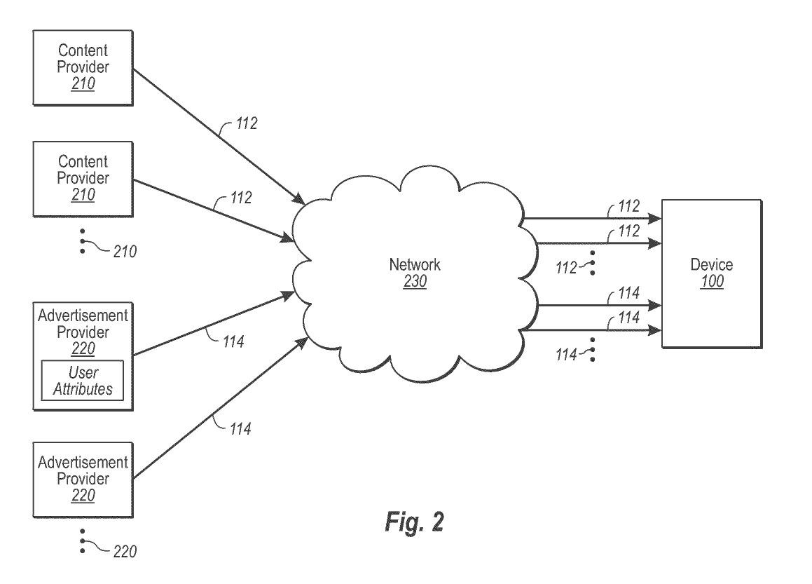

FIG. 2 illustrates one example of an environment for implementing embodiments of the present invention. FIG. 2 includes a system 200 that may be configured to provide content and advertisements, such as content 112 and advertisements 114, to a media device 100. The system 200 includes one or more content providers 210, one or more advertisement providers 220, and a media device 100. The content providers 210 and/or the advertisement providers 220 may communicate with the media device 100 directly or through a network 230 as illustrated in FIG. 2.

The content providers 210 are representative of media sources providing digital or analog content that may be received by the media device 100. The content providers 210 may be sources through which a user may obtain music, Internet data, video, podcasts, text data, and the like or any combination thereof. Exemplary content providers 210 may include, by way of example, satellite sources including digital radio and video, terrestrial sources, internet service providers, music downloads services, peer to peer networks, and the like or any combination thereof. The content providers 210 may include free services that may be accessed free of charge. Furthermore, the content providers 210 may either provide open access to the public, or may require user authentication.

The advertisement providers 220 are representative of media sources providing advertisement information to the media device 100. The advertisement sources may be sources through which a user may obtain advertisement information. Typical advertisement information includes advertisements directed towards particular products or services. This information may also include advertisements directed towards events, destinations, local happenings and the like. It will be appreciated that the advertising information may include information on numerous subjects that are commonly advertised. Exemplary advertisement providers 220 may include terrestrial sources, internet or other network sources, music downloads services, peer to peer networks, and the like or any combination thereof. In many instances, the advertisement providers 220 will be owned and/or operated by manufacturers, service providers, advertisement agencies, and the like that are typically interested in advertising for products and services.

Although FIG. 2 illustrates the content providers 210 as being separate from the advertisement providers 220, this need not be the case. In some embodiments, a single source may provide both the content and the advertisement information. For example, a single provider may provide both a music download stream and an advertisement stream.

In some embodiments, the advertisement information provided by the advertisement providers 220 may be general advertisements directed to all potential users of a media device 100. However, in other embodiments, the advertisement providers 220 may have access to user attributes such as attributes 110 included on media device 100 or to user attributes included at the advertisement provider. These attributes may be used by the advertisement providers 220 when selecting the types of advertisements to send to media device 100. In this way, the advertisements provided to the user of media device 100 are more likely to include subject matter of interest to the user.

Returning to FIG. 2, the network 230 represents any network that is compatible with the devices 100 and the content and advertisement providers 210 and 220 and may include, by way of example, satellite networks, 802.11 networks, personal computer networks (e.g., LAN, WAN), wireless networks (e.g., Bluetooth, WiFi), cellular networks, telephony networks (e.g., landline or PSTN), data networks, the Internet, and the like or any combination thereof.

In operation, the media device 100 receives one or more content data streams 112 from one or more of the content providers 210 and likewise receives one or more advertisement data streams 114 from one or more of the advertisement providers 220. Exemplary data streams 112 and 114 include, by way of example, wired and wireless computer networks (LAN, WAN, Internet, WiFi, WiMax, EVDO, Edge Networks, GPRS, and the like), satellite signals, terrestrial signals, and the like. Further, in some embodiments media device 100 receives the content data streams 112 and the advertisement data streams 114 any time that media device 100 is connected to providers 210 and 220 over network 230. In other embodiments the user must explicitly request that data streams 112 and 114 be sent to media device 100. It will be appreciated that the constant updating of the content data streams 112 and the advertisement data streams 114 will provide for a larger pool of content and advertisements for later selection as will be explained in more detail to follow. Thus, the advertising content 114 stored on a device can be refreshed or updated depending on device connectivity and without input from the user. This allows the content 112 to be performed without continuing to present stale advertisements. Further, this allows content to be performed multiple times with different interstitially associated advertisements.

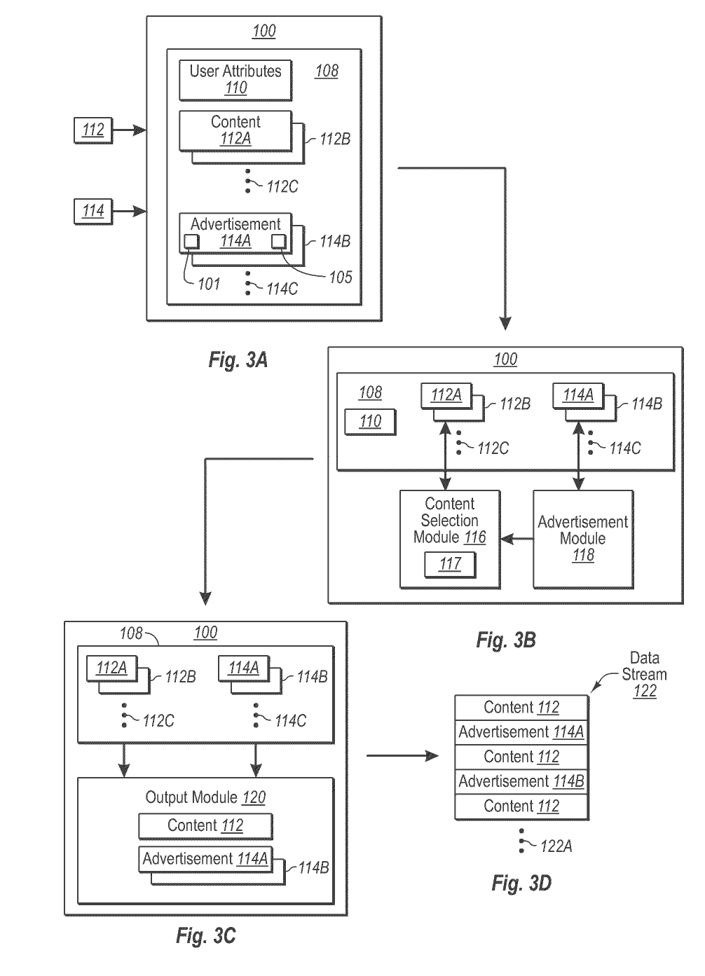

Reference is now made to FIGS. 3A-3D (also referred to as FIG. 3), which illustrate one embodiment of a process flow for media device 100 to interstitially place one or more advertisements between one or more types of content in accordance with one embodiment of the present invention. The process flow will be described in relation to FIGS. 1 and 2 that were previously described, although this by way of example only. In some embodiments, the advertisements 114 are integrated with the content 112, for example as a single file.

In FIG. 3A, the media device 100 may be configured to receive content 112 over a network such as network 230. As previously discussed, the content 112 may be received from multiple sources and may include various types of content such as songs, talk, video or the like. Upon being received by media device 100, the content 112 may be stored in memory 108 or may be performed in real time or time shifted. As shown in FIG. 3, in certain embodiments, the content 112 may be stored as separate pools or groupings of content such as content 112A, content 112B, and potentially any number of additional pools of content as represented by ellipses 112C. For example, content 112A may include music content while content 112B includes talk or video content. Alternatively, content 112A may include content from one source while content 112B and 112C include content from other sources. In some embodiments, the various pools of content may represent play lists and the like determined by the user. Of course it will be appreciated, that content 112 may be stored in any number of pools or groupings as circumstances warrant or the content 112 may be stored as one grouping.

Likewise, the media device 100 may be configured to receive advertisements 114 over a network such as network 230. The advertisements 114 may be received from multiple sources and may include various types of advertising. As with content 112, the advertisements 114 may also be stored in memory 108 as separate pools or groupings as illustrated by advertisements 114A, 114B, and potentially any number of additional pools of advertisements as represented by ellipses 114C. For example, advertisements 114A may include advertisements regarding one subject matter such as restaurants while advertisements 114B include advertisements about vacation spots. Alternatively, advertisements 114A may include advertisements from one source such as a particular store or product while advertisements 114B and 114C include advertisements from other sources such as other stores or products. Of course it will be appreciated, that advertisements 114 may be stored in any number of pools or groupings as circumstances warrant or the advertisements 114 may be stored as one grouping.

As illustrated in FIG. 3B, a user may then select particular content 112 stored in memory 108 to be played by media device 100. For example, the user may select a song list of desired type or perhaps a desired performer or band. Alternatively, the user may select desired video or talk content. The user may also select content 112 that is a combination of different types of content, for example music content mixed with talk content. It will be appreciated that the user may typically select any of the content 112 that is stored in the memory that is of interest to him or her. As is well understood, the user may use the various functionalities of UI 104 previously discussed to make the selection of the desired content.

The selected content 112 is then monitored by content selection module 116 to ascertain the type of content that has been selected by the user. The content selection module 116 also ensures that the selected content conforms to the rules 117 for free content. If the selected content does not conform to the rules 117 or if the performance of the content does not conform to the rules 117, the content selection module will block access to the content. In some embodiments, the content selection module will cause a message to appear in the display 102 informing the user of the rules violation. The message may also indicate how the problem can be overcome to prevent user frustration. For example, the rules 117 may specify that no more than two songs from the same artist may be played in a row. If the user attempts to play more than two songs, the content selection module 116 will prevent the third song from being played and may inform the user to make another content selection. Alternatively, the rules 117 may specify that the user may not repeat play a single song more than two times in a row. If the user attempts to play the song a third time in a row, the content selection module 116 will prevent this and will inform the user of the need to select another song.

In some embodiments, the advertisement module 118 may then access or receive from content selection module 116 the information specifying the type of content 112 that has been selected. The advertisement module 118 may then use this information to select advertisements 114 stored in memory 108 that are related to the selected content. In some embodiments, the advertisements 114 may include attributes 101 that identify the subject matter of the advertisement that may be used by advertisement module 118 when selecting an advertisement related to the selected content.

In still other embodiments, the advertisements 114 may include an expiration or freshness timer 105, which may be included in the attributes 101. The expiration timer 105 is configured to ensure that the particular advertisement 114 is still timely when selected by advertisement module 118. For example, suppose the advertisement 114 related to a concert for a particular performance group. It will be appreciated that playing the advertisement after the date of the concert would be of no benefit to advertisement provider or to the user. Accordingly, the expiration timer 105 will cause an advertisement that is no longer timely to expire such that it will not be selected by the advertisement module 118. The expiration timer 105 may also prompt media device 100 to erase the expired advertisement from memory to ensure that memory 108 is not full of expired advertisements. Note that for ease of illustration, attributes 101 and expiration timer 105 are only shown in FIG. 3A as part of advertisement 114A. It will be appreciated that advertisements 114B and 114C may also include both of these.

For example, suppose the user selected several songs by a particular performance group. Further suppose that the some of the advertisements 114 included advertisements promoting an upcoming concert in the city the user lives in for the particular group. The advertisement module 118 could then select the advertisement related to the upcoming concert based on the user's content selection. Likewise, if the user selected sports talk content, advertisement module 118 could select advertisements 114 associated with sporting goods or with upcoming sporting events. Alternatively, if the selected content 112 was video content such as a television show or a movie, then perhaps advertisement module 118 would select advertisements 114 that dealt with the subject matter of the video content. One of skill in the art will appreciate after reading this description that the principles of the present invention allow for numerous ways to target advertisements based on the type of content that is selected by a user.

In other embodiments, advertisement module 118 may use the user attributes 110 to select advertisements 114 stored in memory 108. In such embodiments, the advertisement module 118 will select advertisements 114 that are associated with one or more of the user attributes. In some embodiments, the advertisements 114 may include attributes that identify the subject matter of the advertisement that may be used by advertisement module 118 when selecting an advertisement related to the one or more user attributes.

For example, if the user attributes 110 indicate that the user of media device 100 is interested in outdoor activities, then advertisement module 118 could select advertisements 114 from outdoor equipment retailers or manufactures or advertisements that dealt with outdoor vacation destinations or events. In addition, the advertisement module 118 could select advertisements 114 associated with events, products, or activities that catered to people with the same gender, age, address, and/or occupation as the user of media device 100. It will be appreciated that the advertisement module 118 may be configured to select various advertisements 114 that are associated with any single user attribute 110 or any combination of user attributes 110 as circumstances warrant. In still further embodiments, advertisement module 118 may be configured to select advertisements 114 based on both the types of content selected by the user and on the user attributes.

In addition, the advertisement module 118 may ensure that the same advertisements 114 are not overplayed. For instance, the advertisement module 118 may be configured to track how often a particular advertisement 114 is selected. If the advertisement module 118 determines that the particular advertisement has been selected too frequently, it will not select this advertisement until other advertisements have been selected. In this way, the advertisements that are provided to the user of media device 100 will not lose their effectiveness through being overplayed. Alternatively, the device will refresh the stored advertisements 114.

In summary, the advertisement module 118 will select various advertisements 114 based on the selected content 112 and/or the user attributes 110. As mentioned, the advertisements 114 may include an expiration timer 105 that ensures that selected advertisements are timely. Thus, the advertisement module ensures that the selected advertisements 114 include a topic that interests the user, are timely, and are varied so as to keep the users interest.

Referring now to FIGS. 3C and 3D, once the particular content 112 and advertisements 114 that are associated with the content have been selected as described, they may be provided to or otherwise accessed by output module 120. The content module 120 produces a data stream 122 that includes the advertisements 114 interstitially placed between the content 112. For example, the output module 120 takes a first portion of the content 112, such as a first song, and places it into data stream 122. An advertisement 114A that has been selected as previously described is then placed into the data stream 122 and is followed by another portion of the content 112, such as a second song, which may be followed by an advertisement 114B. This process may be repeated as needed to provide the desired length of data stream 122 comprised of the desired content and the interstitial advertisements as illustrated by the ellipses 122A.

As will be appreciated, if the advertisements are placed too frequently in the data stream 122, for example in a manner that divides a single song in half, the user's listening experience may be diminished. However, if the advertisements are placed too intermittently, then the value to the advertiser may be diminished. Accordingly, the output module 120 may be configured to interstitially place the advertisements 114 between the content 112 in a logical manner to help ensure the listening and/or viewing pleasure of the user of media device 100 while also ensuring that the value to the advertisers is maintained. For example, if the content 112 is a group of music songs, the output module may place a particular advertisement 114 after each song or perhaps after a series of songs. Likewise, if the content 112 is talk content or video content, the output module 120 may divide the content into time increments, such as five minutes, and place the advertisements 114 between the time increments. It will be appreciated that there are numerous ways that output module 120 may interstitially place the advertisements 114 between the content 112 as circumstances warrant.

It should be noted that although FIG. 3D shows content 112 as being first and last in the data stream 122, this is for illustration only. The principles of the present invention also contemplate a data stream 122 where an advertisement 114 is first and/or last in the data stream 122. Also contemplated in a data stream with only one advertisement and one or two content blocks. Accordingly, in this description and in the claims any reference to an advertisement being interstitially placed between content is defined to include where an advertisement is placed next to or around content in a data stream.

Once the data stream 122 has been prepared by output module 120, it may be played or performed by the media device 100. While being played, the user will hear or see the desired content and the interstitially placed advertisements. To ensure that the user may not skip over the advertisements while listening to data stream 122, output module 120 or some other module of media device 100, may be configured to prevent media device 100 from being able to skip or fast-forward through any of the advertisements. Media device 100 may further be configured to become inoperable should the advertisement module 118 be disabled by the user. Alternatively, the content that is associated with the advertisements may be disabled while the user may have access to other data on the device that is not associated with the advertisements. For example, purchased content may not be tied to interstitially placed content and can be played by the device at any time or method. Accordingly, this helps ensure that if a user accesses or performs content 112 for free, he or she will have to experience to the associated advertisements 114. Alternatively stated, the advertisements will be rendered by the device if the user accesses or performs content that is associated with advertisements. The trigger for determining whether the device will perform an advertisement can be related to accessing the content, downloading the content, partially or completely performing the content, and the like or any combination thereof In this manner, the information management system on the device can control the distribution and/or performance of content that is associated with advertising content.

Advantageously, this process of creating the data stream 122 with both content and advertisements allows for the content to be accessible by the user for free (or at least for a reduced cost) as the advertisements will pay for the use of the content. Accordingly, the user does not need to subscribe to a paid service or the like when accessing desired content. In addition, since the advertisements are interstitially placed at the device side, the advertisements may be specifically targeted to the user in the manner previously described, which may add to the advertisements' effectiveness and value.

The principles of the present invention may be practiced both in real time while media device 100 is online with content providers 210 and advertisement providers 220 and when media device 100 is offline with respect to the content providers. For example, in some embodiments while media device 100 is online, content 112 and advertisements 114 will be downloaded and/or refreshed from the providers 210 and 220 and placed in memory 108. The device receives input from a user selecting content, the advertisement module 118 selects one or more advertisements, and the output module 120 may produce the data stream 122 as previously described all while the media device 100 is online with the providers 210 and 220.

In other embodiments, the content 112 and the advertisements 114 may be placed in memory 108 while the user is online with providers 210 and 220. The media device 100 may then go offline for a period of time. The user may then select the content, the advertisement module 118 may select the advertisements, and output module 120 may produce data stream 122 as previously described all while the media device 100 is offline. Thus, in some embodiments accessing or playing back the content and the interstitially placed advertisements is time shifted from real time.

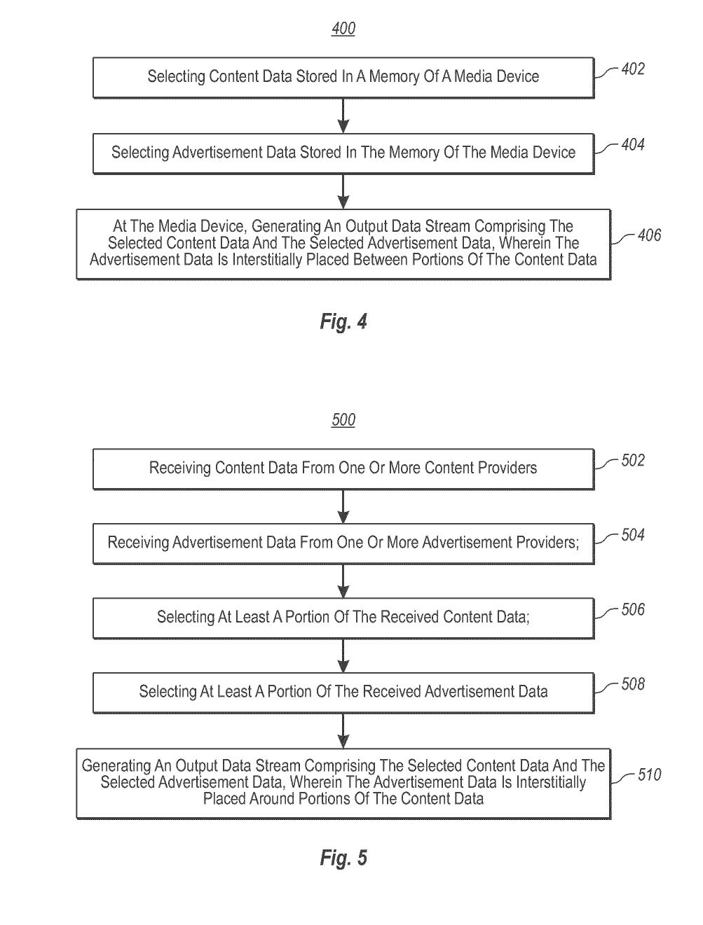

Referring now to FIG. 4, one embodiment of a method 400 for interstitially placing advertisement data between content data is illustrated. The method 400 includes selecting 402 content data stored in a memory of a device, such as a media device. For example, the memory 108 of media device 100 may have placed therein content 112. As previously discussed, the content 112 may be stored as various pools of data and may include music content, talk content, video content, or the like. A user may then select desired content 112 through use of the user interface. This selected content 112 will be monitored by content selection module 116.

The method 400 also includes selecting 404 advertisement data stored in the memory of the media device. For example, the memory 108 of media device 100 may have placed therein advertisements 114. As previously discussed, the advertisements 114 may include attributes that specify the subject matter of the advertisement. The advertisement module 118 may then select advertisement data. In some embodiments, the advertisement module 118 selects the advertisements 114 based on their relation to the selected content 112, while in other embodiments the advertisement module 118 selects the advertisements 114 based on one or more user attributes, such as user attributes 110. In still other embodiments, the advertisements may be selected based on a combination of user attributes and a relationship to the selected content.

Method 400 further includes, at the media device, generating 406 an output data stream that includes the selected content data and the selected advertisement data. In the data stream, the advertisement data is interstitially placed between portions of the content data. For example, the output module 120 of media device 100 may receive or otherwise access the selected content 112 and the selected advertisement data 114. The output module 120 may then generate a data stream 122 by interstitially placing the advertisement data between portions of the content 112. The data stream 122 may then be communicated to the user of media device 100 in the form of being played or performed by media device 100.

Turning now to FIG. 5, one embodiment of a method 500 generating an output data stream for a device is illustrated. The method 500 may be practiced in a system that includes content providers 210 and advertisement providers 220.

The method 500 includes receiving 502 content data from one or more content providers and receiving 504 advertisement data from one or more advertisement providers. For example, the media device 100 may receive content 112 from one or more content providers 210 and may receive advertisement data 114 from one or more advertisement providers 220. As previously mentioned, the media device 100 may connect with providers 210 and 220 over the network 230, which may a wired or wireless network.

The method 500 also includes selecting 506 at least a portion of the received content data. For example, a user may then select desired content 112 through use of the user interface. This selected content 112 will be monitored by content selection module 116.

The method 500 may also selecting 508 at least a portion of the received advertisement data. For example, the advertisement module 118 may select advertisement data 114. In some embodiments, the advertisement module 118 selects the advertisements 114 based on their relation to the selected content 112, while in other embodiments the advertisement module 118 selects the advertisements 114 based on one or more user attributes, such as user attributes 110. In still other embodiments, the advertisements may be selected based on a combination of user attributes and relationship to the content.

In addition, method 500 includes generating 510 an output data stream including the selected content data and the selected advertisement data, wherein the advertisement data is interstitially placed between portions of the content data. For example, the output module 120 of media device 100 may receive or otherwise access the selected content 112 and the selected advertisement data 114. The output module 120 may then generate a data stream 122 by interstitially placing the advertisement data between portions of the content 112 as previously discussed. The data stream 122 may then be communicated to the user of media device 100 in the form of being played by media device 100 for the user's enjoyment.

In these examples, the methods illustrated in FIGS. 4 and 5 can occur while a device is online or while a device is offline. The information handling system of the device can be used to ensure that the device renders both the advertisement content along with the other content that has been received from a content provider. The arrangement of the advertisement content relative to the other content can vary and be selected using various factors. For instance, advertisement content can be placed in the other content on the basis of time (e.g., every five minutes) or on the basis of type of content (e.g., at the end of a song). In one embodiment, the content stream can be generated such that the device appears as if it were online and connected to a data stream over a network.

In another embodiment, the information handling system described herein can be used in situations where the device loses an online connection. In this case, the content 112 and the advertisements 114 can be used to provide an experience that is similar to what would be experienced if the user were online. The use of stored content and advertisement content can thus be used to provide an “online experience” when the device is offline. Further, the information handling system can select the content according to the user's actions. For example, if the user was listening to a particular channel on satellite radio or to a particular online data stream, the characteristics of the particular channel or of the data stream (e.g., artist, music genre, etc.) can be used to select content that is consistent with the lost channel or lost data stream. As a result, the user continues to experience content that is expected and receive advertisements that are selected for the user. The information handling system is not limited to using content 112, but may use any content available to the device in this example.

Embodiments herein may comprise a special purpose or general-purpose computer including various computer hardware. Media devices are examples of special purpose computers. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system including a media device that is configured to store content data and is configured to store advertisement data, a method for interstitially placing the advertisement data between the content data, the method comprising:
selecting content data stored in a memory of a media device;
selecting advertisement data stored in the memory of the media device; and
at the media device, generating an output data stream including the selected content data and the selected advertisement data, wherein the advertisement data is interstitially placed between portions of the content data.

2. The method in accordance with claim 1 further comprising communicating the generated data stream to a user of the media device.

3. The method in accordance with claim 1, wherein selecting the content data comprises receiving user input that identifies the content that is to become part of the generated data stream.

4. The method in accordance with claim 1, wherein selecting the advertisement data comprises selecting advertisement data that is related to the subject matter of the selected content.

5. The method in accordance with claim 4, wherein the advertisement data includes one or more attributes that identify the subject matter of the advertisement data.

6. The method in accordance with claim 1, wherein selecting the advertisement data comprises:
accessing one or more user attributes that include information about the user of the media device; and
selecting advertisement data that is related to the one or more user attributes.

7. The method in accordance with claim 1, wherein the generated data stream conforms with one or more rule specifying what selected content may be included in the generated data stream.

8. The method in accordance with claim 1, wherein the content data is one of digital or analog music data, talk audio data, video data, television data, movie data, podcasts, sports data, weather data, news data, or Internet data.

9. In a system including a media device that is configured to receive content data from one or more content providers and is configured to receive advertisement data from one or more advertisement providers, a method for interstitially placing the advertisement data between the content data, the method comprising:
receiving content data from one or more content providers;
receiving advertisement data from one or more advertisement providers;
selecting at least a portion of the received content data;
selecting at least a portion of the received advertisement data; and
generating an output data stream comprising the selected content data and the selected advertisement data, wherein the advertisement data is interstitially placed between portions of the content data.

10. The method in accordance with claim 9, further comprising:
storing the received content data and the received advertisement data in a memory of the media device prior to selecting at least a portion of the received content data and selecting at least a portion of the received advertisement data.

11. The method in accordance with claim 9 further comprising:
communicating the generated data stream to a user of the media device.

12. The method in accordance with claim 9, wherein selecting the content data comprises:
receiving user input that identifies the content that is to become part of the generated data stream.

13. The method in accordance with claim 9, wherein selecting the advertisement data comprises:
selecting advertisement data that is related to the subject matter of the selected content based upon one or more one or more attributes that identify the subject matter of the advertisement data.

14. The method in accordance with claim 9, wherein selecting the advertisement data comprises:
accessing one or more user attributes that include information about the user of the media device; and
selecting advertisement data that is related to the one or more user attributes.

15. The method in accordance with claim 14, wherein the one or more user attributes comprise one or more of the gender, age, address, occupation of the user and/or one or more interests of the user.

16. The method in accordance with claim 9, wherein the content data is one of digital or analog music data, talk audio data, television data, movie data, podcasts, sports data, weather data, news data, or Internet data.

17. The method in accordance with claim 9, wherein the content data and the advertisement data are received from the one or more providers over a network connecting the media device to the one or more providers.

18. A media device configured to generate a data stream that includes advertisement data interstitially placed between content data, the media device comprising:
a memory;
a processing unit;
a selection module configured to select or identify content data received by the media device;
an advertisement module configured to select one or more advertisement data received by the media device; and
an output module configured to access the selected or identified content data and the selected advertisement data and to generate an output data stream comprising the selected or identified content data and the selected advertisement data, wherein the advertisement data is interstitially placed between portions of the content data.

19. The media device in accordance with claim 18, wherein the advertisement module selects the one or more advertisement data based on one or more user attributes or based upon the subject matter of the selected content data.

20. The media device in accordance with claim 18, wherein the media device is one of a satellite radio device, a portable audio player, a portable DVD or CD player, a personal computer, a laptop computer, a server computer, a cellular telephone, a personal digital assistant (PDA), or any combination thereof.
